(19) United States
(12) Patent Application Publication
(10) Pub. No.: US 2026/0210144 A1
(43) Pub. Date: Jul. 23, 2026

(54) POOL CLEANING APPARATUS

(71) Applicant: Quilo Technology (Jiaxing) Co., Ltd., Jiaxing (CN)

(72) Inventors: Le Zhang, Jiaxing (CN); Pengfei Lin, Jiaxing (CN); Lei Huang, Jiaxing (CN); Hua Liu, Jiaxing (CN); Hui Shen, Jiaxing (CN)

(21) Appl. No.: 19/415,468

(22) Filed: Dec. 10, 2025

(30) Foreign Application Priority Data
Jan. 17, 2025 (CN) 202520120263.X

(51) Int. Cl. E04H 4/16; B01D 29/90; C02F 1/00; C02F 103/42

(52) U.S. Cl. CPC E04H 4/1654; B01D 29/90; C02F 1/001; C02F 2103/42; C02F 2201/008

(57) ABSTRACT

Disclosed is a pool cleaning apparatus, including: a body; a filter assembly having a receiving chamber with an inlet; a water-paddling member movably disposed at the inlet; and a first passage formed between the water-paddling member and the inlet; the pool cleaning apparatus includes a first state and a second state; when both in the first state and the second state, a paddling portion of the water-paddling member and the inlet are at least partially located below a water surface; the water-paddling member moves and drives the paddling portion to paddle water to let target debris be paddled into the receiving chamber through the first passage; wherein a draft H1 of an end portion of the paddling portion in the first state and a draft H2 of the end portion of the paddling portion in the second state satisfy 0<H1<H2.

### CROSS-REFERENCE TO RELATED APPLICATIONS

The present application claims priority to Chinese Patent Application No. 202520120263.X, filed with the China National Intellectual Property Administration on Jan. 17, 2025 and titled “POOL CLEANING APPARATUS”, which is incorporated herein by reference in its entirety.

### TECHNICAL FIELD

This disclosure relates to the technical field of cleaning apparatus and, in particular, to a pool cleaning apparatus.

### BACKGROUND

Existing robotic pool cleaners are generally designed with impellers, which rotate to paddle pool water to clean and collect garbage. Sometimes, the robotic pool cleaner is prevented from continuing its garbage cleaning operation and thus reducing its operational reliability and/or lowering its work efficiency.

### SUMMARY

To solve the aforementioned technical problem, according to one aspect of this disclosure, a pool cleaning apparatus is provided, including: a body; a filter assembly having a receiving chamber with an inlet for debris to enter; a water-paddling member movably disposed at the inlet, where a first passage communicating with the receiving chamber is formed between the water-paddling member and the inlet, and the water-paddling member has a paddling portion; the pool cleaning apparatus includes a first state and a second state; when in the first sate, the pool cleaning apparatus has the maximum inclination relative to a water surface, the paddling portion and the inlet are at least partially located below the water surface, when the water-paddling member moves relative to the body, it drives the paddling portion to paddle water to generate a water flow toward the receiving chamber, and target debris in the water flow is paddled into the receiving chamber through the first passage; where a draft H1 of an end portion of the paddling portion in the first state and a draft H2 of the end portion of the paddling portion in the second state satisfy 0<H1<H2, and in both the first and second states, the debris in the water flow is paddled into the receiving chamber through the first passage.

In some embodiments, the pool cleaning apparatus has a forward direction and a top surface, two ends of the top surface having a first position and a second position, where in the first state, the top surface is at least partially exposed above the water surface, a distance H3 between the first position and a waterline is greater than a distance H4 between the second position and the waterline, and the inlet is close to the first position.

According to another aspect of this disclosure, a pool cleaning apparatus is provided, including: a body; a filter assembly having a receiving chamber with an inlet for debris to enter; a water-paddling member movably disposed at the inlet, where a first passage communicating with the receiving chamber is formed between the water-paddling member and the inlet, and the water-paddling member has a paddling portion; the pool cleaning apparatus includes a first state in which the pool cleaning apparatus has the maximum inclination relative to a water surface, the paddling portion and the inlet are at least partially located below the water surface, when the water-paddling member moves relative to the body, it drives the paddling portion to paddle water to generate a water flow toward the receiving chamber, and target debris in the water flow is paddled into the receiving chamber through the first passage; the pool cleaning apparatus has a forward direction and a top surface, two ends of the top surface having a first position and a second position, where in the first state, the top surface is at least partially exposed above the water surface, a distance H3 between the first position and a waterline is greater than a distance H4 between the second position and the waterline, and the inlet is close to the first position.

According to yet another aspect of this disclosure, a pool cleaning apparatus is provided, including: a body; a filter assembly having a receiving chamber with an inlet for debris to enter; a water-paddling member movably disposed at the inlet, where a first passage communicating with the receiving chamber is formed between the water-paddling member and the inlet, and the water-paddling member has a paddling portion provided with filter holes; the pool cleaning apparatus includes a first state in which the paddling portion and the inlet are at least partially located below a water surface, when the water-paddling member moves relative to the body, it drives the paddling portion to paddle water to generate a water flow toward the receiving chamber, the water flow containing foreign objects is partially filtered through the filter holes, and target debris in the water flow is paddled into the receiving chamber through the first passage.

In some embodiments, the pool cleaning apparatus further includes a second state, where the pool cleaning apparatus has the maximum inclination relative to the water surface in the first state, a draft H1 of an end portion of the paddling portion in the first state and a draft H2 of the end portion of the paddling portion in the second state satisfy 0<H1<H2, and in both the first and second states, the water flow containing foreign objects is partially filtered through the filter holes and the target debris in the water flow is paddled into the receiving chamber through the first passage.

In some embodiments, the pool cleaning apparatus has a forward direction and a top surface, two ends of the top surface having a first position and a second position, where in the first state, the top surface is at least partially exposed above the water surface, a distance H3 between the first position and the water surface is greater than a distance H4 between the second position and the water surface, and the inlet is close to the first position.

In some embodiments, the paddling portion includes: a frame body having at least one mounting area; and at least one filter member disposed in the mounting area and connected to the frame body, where the filter member is provided with the filter holes.

In some embodiments, the frame body has a higher hardness than the filter member, and in the first state, the water flow passes through the filter member, and the filter member has greater surface deformation than the frame body.

In some embodiments, the filter assembly includes a filter housing, where a side of the filter housing facing the forward direction of the pool cleaning apparatus is provided with the inlet, and the inlet is disposed away from a bottom surface of the filter housing.

In some embodiments, in the first state, along a direction of the water flow entering the receiving chamber, the water-paddling member is located downstream of the inlet.

In some embodiments, a minimum distance L along a height direction between the water-paddling member and an inner wall at a bottom of the inlet is 0-20 mm.

In some embodiments, a periphery of the filter assembly is provided with a wall body for filtering, where the wall body has through holes, water inside the filter assembly flows out of the filter assembly through the through holes, and the water-paddling member is at least partially located inside the filter assembly.

In some embodiments, the water-paddling member is disposed on the filter assembly.

In some embodiments, the filter assembly includes a filter housing and a lifting handle coveringly disposed above the filter housing, the lifting handle having a positioning portion and an operating portion, where the positioning portion and the operating portion are located on a side of the lifting handle away from the receiving chamber, the positioning portion is configured to cooperate with the body for positioning, the operating portion is configured to operate the filter assembly, and the filter housing has a cover that can be opened/closed.

In some embodiments, the body includes an accommodating cavity and a top cover, where the accommodating cavity has a second opening, the top cover is movably coverable over the second opening, and the filter assembly is detachably disposed within the accommodating cavity through the second opening.

In some embodiments, the water-paddling member is disposed on the filter assembly, the filter assembly includes a filtering state and a detached state, where in the filtering state, the filter assembly is located within the accommodating cavity, and in the detached state, the filter assembly and the water-paddling member are moved away from the accommodating cavity through the second opening.

In some embodiments, the paddling portion is detachably disposed on the water-paddling member.

In some embodiments, the pool cleaning apparatus further includes a drive mechanism, the drive mechanism including a first drive assembly and a second drive assembly, where the first drive assembly is disposed on the body and configured to generate a first driving force, the second drive assembly is at least partially disposed on the body and configured to generate a second driving force, the body moves in water under action of the first driving force, and the second driving force is configured to drive the water-paddling member to rotate relative to the body.

In some embodiments, the second driving force includes a rotational force for driving the water-paddling member to rotate, and/or a moving force for driving the water-paddling member to move, the moving force including a force parallel to a direction of the water flow entering the receiving chamber.

In some embodiments, along the forward direction of the pool cleaning apparatus, the body includes a front portion and a rear portion, the first drive assembly is disposed at the rear portion of the body, the water-paddling member is disposed at the front portion of the body, the filter assembly is disposed between the water-paddling member and the first drive assembly, and in the first state, the first driving force acts as a force pushing the water flow to maintain the body moving forward and inclined upward.

In the technical solution provided by this disclosure, by arranging the water-paddling member at the inlet of the filter assembly, when the water-paddling member moves, the paddling portion of the water-paddling member can paddle the water surface, thereby driving the debris on the water surface to enter the filter assembly through the inlet and the first passage, thus achieving the collection and cleaning of the target debris such as garbage. In this embodiment, the draft H1 of the end portion of the paddling portion when the pool cleaning apparatus is in the first state and the draft H2 of the end portion of the paddling portion when the pool cleaning apparatus is in the second state satisfy 0<H1<H2. Consequently, whether in the first state or in the second state, the draft of the paddling portion can be maintained at least partially below the water surface and not detached from the water surface, such that even when the body of the pool cleaning apparatus tilts relative to a horizontal plane, the water-paddling member can still remain below the water surface, enabling the paddling portion to always effectively paddle the water surface and the garbage thereon, ensuring that the pool cleaning apparatus can stably and reliably perform cleaning work consistently, and improving operational reliability and/or work efficiency.

### BRIEF DESCRIPTION OF THE DRAWINGS

To describe the technical solutions in the embodiments of this disclosure or in the prior art more clearly, the following will briefly describe the accompanying drawings needed for describing the embodiments or the prior art. Apparently, the accompanying drawings in the following description show some embodiments of this disclosure, and a person of ordinary skill in the art may further derive other drawings from these accompanying drawings without making creative efforts.

FIG. 1 is an axonometric view of a pool cleaning apparatus according to this disclosure;

FIG. 2 is a side view of the pool cleaning apparatus shown in FIG. 1;

FIG. 3 is a schematic structural view of a filter assembly and a water-paddling member of the pool cleaning apparatus shown in FIG. 1 in a first state;

FIG. 4 is a sectional view of the filter assembly and the water-paddling member in the first state;

FIG. 5 is a sectional view of the filter assembly and the water-paddling member in a second state;

FIG. 6 is a schematic structural diagram of the water-paddling member;

FIG. 7 is a schematic structural diagram of the filter assembly;

FIG. 8 is a schematic state diagram of the pool cleaning apparatus moving forward in the first state; and

FIG. 9 is a cross-sectional view of the pool cleaning apparatus at a second drive assembly.

Reference numerals used in the figures:
10: body; 11: top cover; 12: top surface; 121: first position; 122: second position; 13: accommodating cavity; 20: filter assembly; 21: inlet; 22: filter housing; 23: through hole; 24: lifting handle; 241: positioning portion; 242: operating portion; 243: curved segment; 25: receiving chamber; 26: first passage; 27: wall body; 30: water-paddling member; 31: paddling portion; 311: frame body; 312: mounting area; 313: filter member; 314: filter hole; 32: cylinder portion; 40: first drive assembly; and 50: second drive assembly.

### DETAILED DESCRIPTION OF THE EMBODIMENTS

The technical solutions of this disclosure will be clearly and completely described below with reference to the accompanying drawings. Apparently, the described embodiments are only some rather than all of the embodiments of this disclosure. This disclosure will be described in detail below with reference to the accompanying drawings and in conjunction with embodiments. It should be noted that the embodiments of this disclosure and the features in the embodiments can be combined with each other in case of no conflict.

It should be noted that the terms “first”, “second”, and the like in the specification and claims of this disclosure and in the above accompanying drawings are intended to distinguish between similar objects but do not necessarily indicate a specific order or sequence.

In this disclosure, unless otherwise stated, the directional terms such as “upper, lower, top, and bottom” are generally used with respect to a direction shown in the accompanying drawings, or with respect to a component in a vertical, perpendicular, or gravitational direction; similarly, for ease of understanding and description, the terms “inner and outer” refer to inner and outer sides relative to an outline of a component, but the above directional terms are not intended to limit this disclosure.

To solve the problem that existing robotic pool cleaners in the prior art may malfunction due to their impellers detaching from the water surface, this disclosure provides a pool cleaning apparatus.

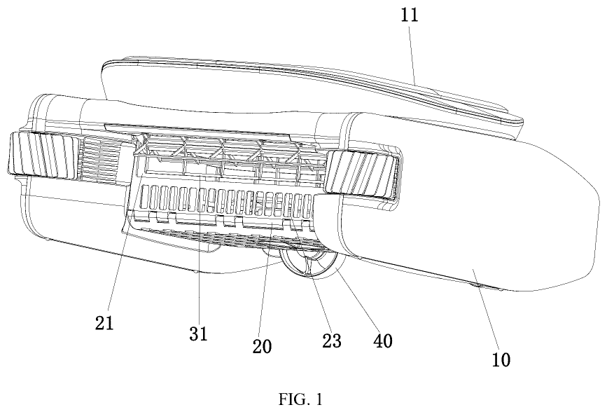

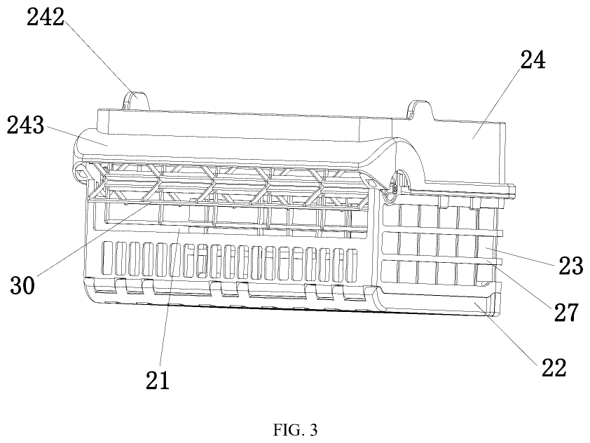

As shown in FIGS. 1-9, this embodiment provides a pool cleaning apparatus, including: a body 10, a filter assembly 20 having a receiving chamber 25 with an inlet 21 for debris to enter, and a water-paddling member 30 movably disposed at the inlet 21, where a first passage 26 communicating with the receiving chamber 25 is formed between the water-paddling member 30 and the inlet 21, and the water-paddling member 30 has a paddling portion 31; the pool cleaning apparatus includes a first state in which the pool cleaning apparatus has the maximum inclination relative to a water surface, the paddling portion 31 and the inlet 21 are at least partially located below the water surface, when the water-paddling member 30 moves relative to the body 10, it drives the paddling portion 31 to paddle water to generate a water flow toward the receiving chamber 25, and target debris in the water flow is paddled into the receiving chamber 25 through the first passage 26. In some embodiments, the first state is a state in which the pool cleaning apparatus is in normal operation.

In this embodiment, by arranging the water-paddling member 30 at the inlet 21 of the filter assembly 20, when the water-paddling member 30 moves, the paddling portion 31 of the water-paddling member 30 can paddle the water surface, thereby driving the debris on the water surface to enter the filter assembly 20 through the inlet 21 and the first passage 26, thus achieving the collection and cleaning of the target debris such as garbage. In this embodiment, a draft H1 of an end portion of the paddling portion 31 when the pool cleaning apparatus is in the first state and a draft H2 of the end portion of the paddling portion 31 when the pool cleaning apparatus is in a second state satisfy 0<H1<H2. Consequently, whether in the first state or in the second state, the draft of the paddling portion 31 can be maintained at least partially below the water surface, such that even when the body 10 of the pool cleaning apparatus tilts relative to a horizontal plane during normal operation, the water-paddling member 30 can still remain below the water surface, enabling the paddling portion 31 to always effectively paddle the water surface and the garbage thereon, ensuring that the pool cleaning apparatus can stably and reliably perform cleaning work consistently, and improving operational reliability. In some embodiments, the second state is a state in which the pool cleaning apparatus is in normal operation.

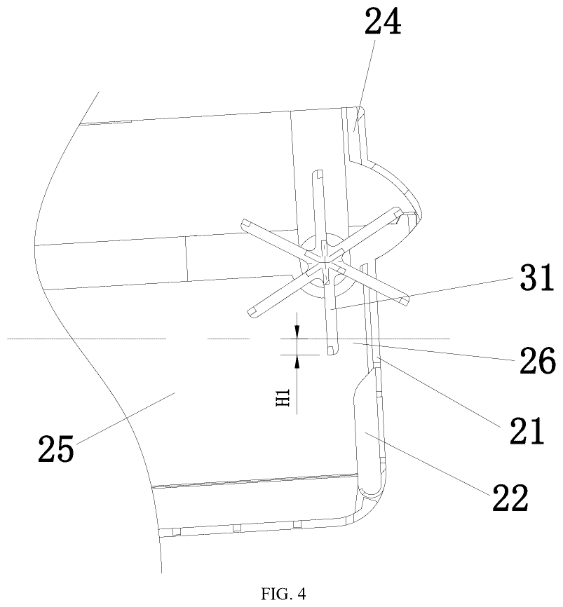

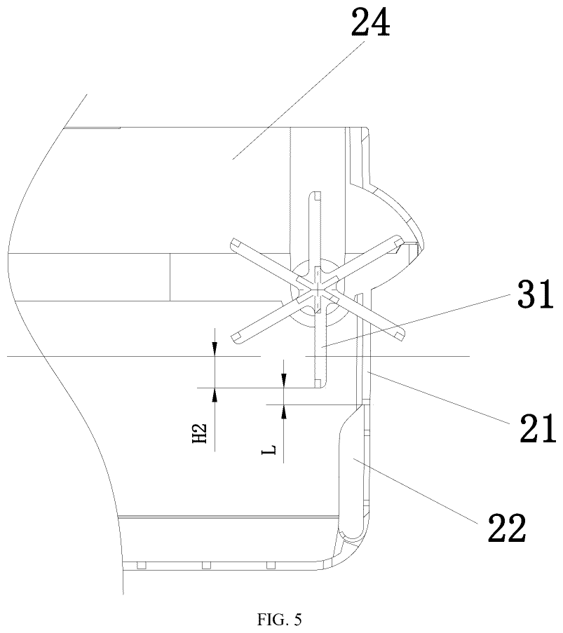

As shown in FIGS. 4 and 5, in this embodiment, during normal operation, the pool cleaning apparatus further includes a second state in addition to the first state, where a draft H1 of an end portion of the paddling portion 31 in the first state as shown in FIG. 4 and a draft H2 of the end portion of the paddling portion 31 in the second state as shown in FIG. 5 satisfy H1<H2, and in both the first and second states, the debris in the water flow is paddled into the receiving chamber 25 through the first passage 26. The first state may represent a state during normal forward operation, for example, when the pool cleaning apparatus is moving forward normally with its drive portion properly activated, while the second state may represent a state under certain special circumstances, for example, when the drive portion is not activated or when the pitch angle is reduced, in which case the front end of the pool cleaning apparatus descends, causing the draft of the end portion of the paddling portion 31 in the second state to increase compared to that in the first state. However, whether in the first state or in the second state, the pool cleaning apparatus can still operate, and the paddling member can paddle the target debris such as garbage in the pool water into the filter assembly 20, achieving garbage collection and cleaning. In practical use, due to influences from the surrounding environment such as slight changes in water flow and air currents, it is difficult for the pool cleaning apparatus to remain stable in the first state continuously. Therefore, there may be situations where it switches back and forth between the first state and the second state, which generally does not affect the normal operation of the pool cleaning apparatus. In another embodiment, the second state of the pool cleaning apparatus is the operating state where the inclination of the pool cleaning apparatus relative to the water surface is minimal. In various other operating states of the pool cleaning apparatus, the end portion of the paddling portion 31 remains below the water surface. It should be further noted that the normal operating states of the pool cleaning apparatus do not include extreme operating conditions caused by external environmental factors. Extreme external environmental factors include, but are not limited to, high wind levels, large water surface waves, and other uncommon service environments of pools, which will not be elaborated herein. In other words, an abnormal operation differing from the normal operation is defined as a case in which the pool cleaning apparatus has an error or is prevented from working by an external factor, such as extreme external environmental factor.

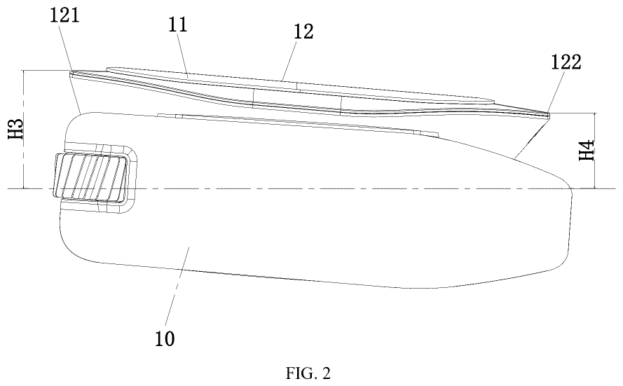

As shown in FIG. 2, the pool cleaning apparatus according to this embodiment has a forward direction and a top surface 12, two ends of the top surface 12 having a first position 121 and a second position 122, where the first position 121 and the second position 122 are arranged along a straight line of the forward direction of the pool cleaning apparatus. As an example, the first position 121 is the front end position of the top surface 12 of the pool cleaning apparatus, i.e., the left end of the top surface 12 in FIG. 2 is the first position 121, while the second position 122 is the rear end position of the top surface 12 of the pool cleaning apparatus, i.e., the right end of the top surface 12 in FIG. 2 is the second position 122.

In the first state, the pool cleaning apparatus operates in the normal forward manner, without occurrences such as the drive portion not being activated or a reduction in the pitch angle. At this time, the top surface 12 is at least partially exposed above the water surface, and the distance H3 between the first position 121 and the waterline is greater than the distance H4 between the second position 122 and the waterline. That is, the front end of the top surface 12 of the pool cleaning apparatus is higher than the rear end of the top surface 12, causing the pool cleaning apparatus to form a configuration with the front end tilting upward. To ensure that garbage can enter the receiving chamber 25 as much as possible, in this embodiment, the inlet 21 is disposed close to the first position 121, i.e., the distance between the inlet 21 and the first position 121 is less than the distance between the inlet 21 and the second position 122. More specifically, the inlet 21 is disposed on the front end face of the pool cleaning apparatus, and the water-paddling member 30 is also disposed at this position. Thereby, as the pool cleaning apparatus moves forward, the water flow and garbage have a tendency to spontaneously flow into the receiving chamber 25 through the inlet 21, thus improving the effectiveness of garbage collection. Certainly, besides being disposed on the front end face, the inlet 21 may also be disposed at other positions such as the left and right side surfaces adjacent to the front end face.

It should be noted that this embodiment describes the pool cleaning apparatus placed on the water surface for cleaning the pool water surface as an example. Correspondingly, the first state and the second state are states where the pool cleaning apparatus is placed on the water surface. Certainly, the pool cleaning apparatus may also have other states and can be used to clean other parts as needed.

As shown in FIGS. 1, 4, and 6, in this embodiment, the paddling portion 31 is provided with filter holes 314. The filter holes 314 allow water to flow through normally, while garbage cannot pass through the filter holes 314. Thus, in both the first and second states, when the water-paddling member 30 moves relative to the body 10 and drives the paddling portion 31 to paddle water to generate a water flow toward the receiving chamber 25, garbage remains on the side of the paddling portion 31 facing the inlet 21. The paddling portion 31 drives the water flow and the garbage thereon, and the water flow passes through the paddling portion 31 via the filter holes 314, while the garbage, being unable to pass through the filter holes 314, is paddled into the receiving chamber 25 by the paddling portion 31. In this way, a mode of operation is formed, where the water flow containing foreign objects is filtered through the filter holes 314: the water flow passes through the filter holes 314, while the garbage is paddled into the receiving chamber 25 through the first passage 26, thereby achieving garbage collection and cleaning.

In conventional solutions without filter holes 314, although the blades of the impeller also paddle the water flow when rotating, since the water flow tends to move and discharge toward both sides of the blades, it can cause some garbage to be carried away from the blade coverage area, leading to the garbage being pushed away from the receiving chamber 25. However, in this embodiment, due to the provision of the filter holes 314, the water flow can pass through the paddling portion 31 via the filter holes 314, thereby reducing the water flow toward both sides of the paddling portion 31. This consequently mitigates the situation where the garbage is carried away by the water flow from the coverage area of the paddling portion 31, thus preventing the garbage from being expelled out of the receiving chamber 25 from the inlet 21, avoiding garbage regurgitation, improving the effect of the water-paddling member 30 in paddling garbage into the receiving chamber 25, and enhancing the effectiveness of garbage collection and cleaning.

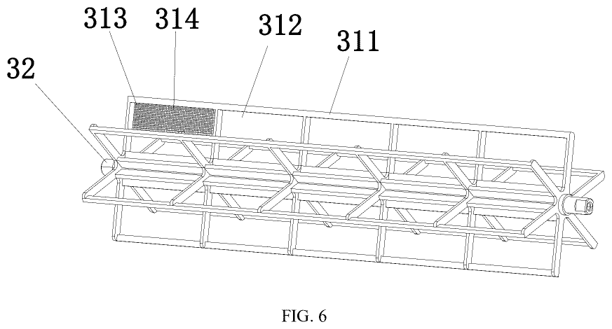

As shown in FIG. 6, in this embodiment, the water-paddling member 30 rotates as a whole. The water-paddling member 30 includes a central cylinder portion 32 and a peripheral paddling portion 31, where the cylinder portion 32 is cylindrical, and a rotating shaft can be inserted through the center of the cylinder portion to achieve the effect of driving the cylinder portion 32 to rotate by driving the rotating shaft. Alternatively, the cylinder portion 32 can serve as a rotating shaft component, directly driving the cylinder portion 32 to rotate the water-paddling member 30. In both the first and second states, the axis of the cylinder portion 32 extends substantially horizontally. The paddling portion 31 is located on the peripheral side of the cylinder portion 32 and extends radially from the cylinder portion 32. Thus, when the cylinder portion 32 rotates, the paddling portion 31 rotates along with the cylinder portion 32, enabling switching between above and below the water surface. When the paddling portion 31 inserts into the water surface from rotating above the water surface, it can paddle the water surface and the garbage thereon. As the cylinder portion 32 rotates, the garbage is paddled into the receiving chamber 25.

In this embodiment, preferably, a plurality of paddling portions 31 is provided, with at least some of the paddling portions 31 arranged at intervals along the circumference of the cylinder portion 32. In this way, as the cylinder portion 32 rotates, the circumferentially arranged paddling portions 31 can sequentially paddle the water surface, thereby achieving continuous garbage cleaning and improving cleaning efficiency.

Based on the above structural configuration, the water-paddling member 30 in this embodiment overall forms an impeller structure, with the impeller arranged horizontally, so that the paddling portions 31, serving as blades, can paddle the water surface and garbage. Certainly, besides the aforementioned structural configuration, the water-paddling member 30 can also be configured in other structural forms. For example, the water-paddling member 30 can be a plate-like member that moves both horizontally and vertically. Through the vertical movement of the water-paddling member 30, it can switch between above and below the water surface. The part of the water-paddling member 30 that moves and switches between above and below the water surface is the paddling portion 31. The horizontal movement of the water-paddling member 30 can paddle the water surface and garbage into the receiving chamber 25. Through the coordination of horizontal and vertical movements, the water-paddling member 30 can first move upward to leave the water surface, then move horizontally away from the inlet 21, then move downward to insert into the water surface, and then move toward the inlet 21, thereby paddling the water flow and garbage into the receiving chamber 25 to achieve garbage collection and cleaning. When the water-paddling member 30 is movable, it may be configured as vertically immovable, allowing the water-paddling member 30 to move only horizontally. The water-paddling member 30 can also paddle garbage from the water surface into the receiving chamber 25 through reciprocating horizontal movement.

In some embodiments the paddling portion 31 and the cylinder portion 32 can be integrally or separately formed. When integrally formed, the two can be injection molded as a whole, causing the water-paddling member 30 to be a whole component with better structural strength. When separately formed, insertion holes can be arranged on the peripheral side of the cylinder portion 32, and the paddling portion 31 can be inserted into these holes, allowing the paddling portion 31 to be detachably arranged on the water-paddling member 30. When the water-paddling member 30 needs replacement, it is not necessary to remove the entire water-paddling member 30; instead, the paddling portion 31 can be pulled out and replaced with a new one, making subsequent maintenance and repair more convenient and efficient.

As shown in FIG. 6, the paddling portion 31 in this embodiment includes a frame body 311 and a filter member 313, where the frame body 311 may be in a frame structure, forming a mounting area 312 therein, the mounting area 312 is a relatively large space, and the filter member 313, provided with the filter holes 314, is disposed within the mounting area 312 and connected to the frame body 311. Thus, the frame body 311 serves as the main body of the paddling portion 31, providing support and connection, while the filter member 313 acts as the part of the paddling portion 31 that filters the water flow, preventing the water flow from moving away from the receiving chamber 25 and thereby avoiding garbage regurgitation.

In some embodiments, the number of mounting areas 312 and filter members 313 may be set as needed. The paddling portion 31 may be provided with only one mounting area 312, or it may be provided with a plurality of mounting areas 312 simultaneously. In the latter case, the mounting areas 312 can be arranged sequentially across the surface of the plate-like paddling portion 31 to increase the overall area, or they can be arranged sequentially along the thickness direction of the paddling portion 31 to achieve multi-layer filtration. Similarly, the mounting area 312 may be provided with only one filter member 313, or it may be provided with a plurality of filter members 313. In this embodiment, the paddling portion 31 is provided with a plurality of mounting areas 312, each containing one filter member 313. This configuration, on one hand, increases the area covered by the filter members 313, ensuring that most of the surface of the paddling portion 31 is equipped with the filter holes 314, thereby enhancing the effect of preventing garbage regurgitation. On the other hand, the frame body 311 provides good support, ensuring the overall structural strength of the paddling portion 31 and preventing significant deformation of the paddling portion 31 during garbage paddling, thus guaranteeing stable and reliable operation. The one-to-one correspondence between the mounting areas 312 and the filter members 313 simplifies the structure and makes processing and installation more convenient while ensuring filtration effects.

This embodiment is provided with six paddling portions 31, each having five mounting areas 312. Thus, the paddling portions 31 are uniformly distributed at 60-degree intervals along the circumference of the cylinder portion 32. The five mounting areas 312 are arranged at intervals on the paddling portion 31 along the axial direction of the water-paddling member 30. Adjacent mounting areas 312 are separated by beams of the frame body 311, and each mounting area 312 is provided with an integral piece of filter screen serving as the filter member 313, thereby forming the water-paddling member 30. Certainly, as mentioned above, the specific configuration of the aforementioned parts can be adjusted as needed and is not limited to the configuration described in this embodiment.

In some embodiments, in this embodiment, the frame body 311 has a higher hardness than the filter member 313, which ensures the structural strength of the frame body 311 and guarantees that the overall structural strength of the paddling portion 31 is sufficient to paddle garbage into the receiving chamber 25. Due to the higher hardness of the frame body 311, in the first state, when the water flow passes through the filter member 313, the filter member 313 has greater surface deformation than the frame body 311. This allows the filter member 313 to undergo a certain degree of deformation and potentially form a recess, which enables the filter member 313 to provide a certain catching effect on garbage, further preventing garbage regurgitation. Certainly, the hardness of the filter member 313 and the frame body 311 can also be set to be approximately the same, causing the filter member 313 to undergo little to no deformation. While the filter member 313 would not provide a catching effect in this case, it can further enhance the overall structural strength of the paddling portion 31, allowing the water-paddling member 30 to be used for cleaning heavier and harder debris, which is beneficial for improving the compatibility and cleaning effectiveness of the pool cleaning apparatus.

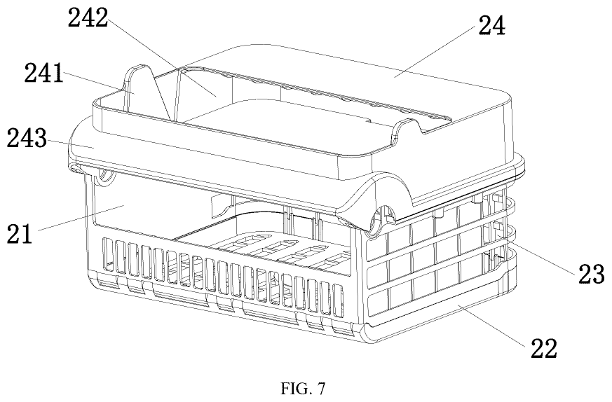

As shown in FIG. 7, in this embodiment, the filter assembly 20 includes a filter housing 22, which forms the receiving chamber 25, and the inlet 21 is also arranged on the filter housing 22. The inlet 21 is located on a side of the filter housing 22 facing the forward direction and is spaced apart from the bottom surface of the filter housing 22, thereby positioning the inlet 21 at an upper position on the front end face of the filter housing 22. Thus, when the pool cleaning apparatus is placed on the water surface, the filter housing 22 can be located partially below the water surface, while the inlet 21 can be located at the waterline. The upper edge of the inlet 21 is above the waterline, while the lower edge thereof is below the waterline, causing the waterline to pass through the inlet 21. This ensures that when the paddling portion 31 paddles garbage, it can paddle the garbage from the inlet 21 into the receiving chamber 25, guaranteeing the effectiveness of garbage collection.

Simultaneously, to prevent partial water flow paddled into the receiving chamber 25 from being discharged out of the receiving chamber 25 through the inlet 21, which would cause regurgitation, the side wall of the filter housing 22 in this embodiment is provided with a wall body 27 for filtering. The wall body 27 is provided with through holes 23, which are smaller than the garbage in size. Thus, the water flow entering the receiving chamber 25 through the inlet 21 can flow out of the filter assembly 20 via the through holes 23, further preventing garbage regurgitation. Additionally, after garbage collection is completed and the user lifts the pool cleaning apparatus out of the water surface, water within the receiving chamber 25 can drain out through the through holes 23, enabling the filter assembly 20 to have an automatic filtering function. This eliminates the need for manual water pouring, improving ease of use.

The wall body 27 of the filter housing 22 in this embodiment includes front and rear end faces, left and right side faces, and a bottom face. In this embodiment, the through holes 23 are arranged on the rear end face, the left and right side faces, and the bottom face. The number of through holes 23 can be adjusted according to the area of each wall body 27. The through holes 23 can also be arranged on the front end face, but should be kept away from the inlet 21; preferably, they are arranged on the lower part of the front end face to avoid affecting the inlet 21.

In this embodiment, the filter assembly 20 further includes a lifting handle 24, which is coveringly disposed above the filter housing 22. The lifting handle 24 in this embodiment has a positioning portion 241 and an operating portion 242, where the positioning portion 241 and the operating portion 242 are located on a side of the lifting handle 24 away from the receiving chamber 25, that is, both the positioning portion 241 and the operating portion 242 are located on the outer side surface of the lifting handle 24. The positioning portion 241 is configured to cooperate with the body 10 for positioning, and when the filter housing 22 is installed onto the body 10, the mounting position of the filter assembly 20 can be located through the cooperation between the positioning portion 241 and the body 10. The positioning portion 241 can be configured as, for example, a positioning protrusion; correspondingly, positioning structures such as positioning protrusions or positioning holes can be arranged on the body 10, and positioning installation can be achieved through the cooperation between the positioning protrusions and the positioning structures. The operating portion 242 is configured to operate the filter assembly 20. The user can operate the lifting handle 24 and the filter assembly 20 through the operating portion 242. The operating portion 242 can also be configured as, for example, a lifting handle or hole/slot, as long as it facilitates operation by the user. The operating portion 242 in this embodiment is configured as a relatively large hole, allowing the user's hand to reach into the operating portion 242 to contact the lower surface of the lifting handle 24 for operation.

The filter housing 22 in this embodiment employs a split configuration, being assembled from multiple plates, where one or more of these plates can serve as a cover. The cover can be opened/closed, specifically either by flipping it open/closed or by completely detaching it for opening/closing. The cover in this embodiment uses a downward-flipping opening arrangement. When it is necessary to remove garbage from the receiving chamber 25, the user can flip the cover downward to open the filter housing 22 and pour out the garbage therein.

As shown in FIG. 7, to accommodate the rotation of the impeller-shaped water-paddling member 30, the front end portion of the lifting handle 24 in this embodiment is provided with a curved segment 243. The curved segment 243 may employ a downwardly opening arc-shaped structure. The water-paddling member 30 is located inside the arc-shaped structure, and the curved segment 243 is coveringly disposed above the water-paddling member 30. The bottom end of the curved segment 243 is preferably located above the rotation axis of the water-paddling member 30, so that the curved segment 243 will not impair the effect of the water-paddling member 30 in paddling garbage.

In this embodiment, the water-paddling member 30 is at least partially located inside the filter assembly 20 and disposed on the filter assembly 20. That is to say, in this embodiment, the water-paddling member 30 is installed inside the filter assembly 20 and connected to the filter housing 22 of the filter assembly 20. During installation, mounting holes are arranged on opposite inner sides of the filter housing 22, allowing both ends of the cylinder portion 32 to be inserted into the mounting holes, thereby achieving a rotatable installation of the water-paddling member 30. Certainly, in addition to being installed on the filter assembly 20, the water-paddling member 30 can also be disposed outside the filter assembly 20, in which case the water-paddling member 30 can be installed on the body 10.

As shown in FIG. 4, preferably, in the first state, along the direction of the water flow entering the receiving chamber 25, which is opposite to the forward direction of the body 10, the water-paddling member 30 is located downstream of the inlet 21, i.e., in the direction from right to left in FIG. 2, the water-paddling member 30 is located on the left side of the inlet 21. Thus, as the body 10 moves forward, garbage will first generally reach the area around the inlet 21. At this point, the garbage is within the paddling range of the water-paddling member 30, and the paddling portion 31 can paddle the water flow and garbage, causing the garbage to fully enter the receiving chamber 25. This method can further prevent garbage regurgitation and ensure the effectiveness of garbage collection. It should be noted that the water-paddling member 30 is located downstream of the inlet 21; to be more accurate, the rotation axis of the water-paddling member 30 is located downstream of the inlet 21. When the water-paddling member 30 rotates, the end portion of the paddling portion 31 may rotate to a position upstream of the inlet 21, thereby allowing garbage in the area upstream of the inlet 21 to be paddled into the receiving chamber 25 by the water-paddling member 30, without requiring the garbage to first enter the inlet 21 before being paddled by the water-paddling member 30, which helps improve cleaning efficiency. Certainly, the water-paddling member 30 can also be arranged upstream of the inlet 21, in which case the area covered by the water-paddling member 30 is larger, allowing it to paddle garbage located far from the inlet 21 towards the inlet 21. However, the anti-regurgitation effect of this configuration might be reduced.

As shown in FIG. 5, in this embodiment, based on the aforementioned cooperation between the water-paddling member 30 and the inlet 21, the minimum distance L along the height direction between the water-paddling member 30 and the inner wall at the bottom of the inlet 21 in this embodiment can be made smaller. This is more conducive to garbage collection, thereby improving the effectiveness of garbage collection. The aforementioned minimum distance L essentially refers to the vertical distance between the lower end portion of the paddling portion 31 of the water-paddling member 30 and the horizontal edge line at the lower part of the inlet 21 when the paddling portion 31 moves to a vertical state.

Preferably, the minimum distance L along the height direction between the water-paddling member 30 and the inner wall at the bottom of the inlet 21 is 0-20 mm, for example, 0 mm, 5 mm, 6 mm, 10 mm, 15 mm, or 20 mm, thereby improving the effectiveness of garbage collection. Further preferably, the minimum distance L is 0-10 mm, for example, 0 mm, 2 mm, 5 mm, 6 mm, 8 mm, or 10 mm. When the minimum distance L is 0 mm, the lower end portion of the vertical paddling portion 31 is flush with the horizontal edge line at the lower part of the inlet 21. Certainly, the specific value and range of the minimum distance L are not limited to the parameters provided in this embodiment and may be adjusted accordingly based on actual requirements.

As shown in FIGS. 1, 2, and 8, in this embodiment, the body 10 includes an accommodating cavity 13 and a top cover 11 and is generally configured in an inverted concave shape, where the central portion is the accommodating cavity 13. The accommodating cavity 13 extends to the bottom of the body 10, and the bottom surface, bottom front surface, and bottom rear surface of the body 10 are all provided with a first opening, while the left and right side surfaces serve as support portions that float on the water surface. The bottom surface and front and rear side surfaces of the filter assembly 20 are exposed outside the body 10 through the first openings, thereby achieving garbage collection and filtration. In addition to the first opening at the bottom, the accommodating cavity 13 also has a second opening. In this embodiment, the second opening is arranged at the top, and preferably on the top surface 12, so that various components installed inside the body 10 can be installed into the body 10 through the second opening. The top cover 11 is movably coverable over the second opening, thereby shielding the second opening and, in cooperation with the body 10, providing a protective effect for the components installed inside the body 10.

Correspondingly, the filter assembly 20 in this embodiment is detachably configured. The filter assembly 20 includes a filtering state and a detached state, where in the filtering state, the filter assembly 20 can be installed into the accommodating cavity 13 through the second opening, thereby achieving the effect of installing the filter assembly 20 inside the accommodating cavity 13 of the body 10, and in the detached state, the filter assembly 20 and the water-paddling member 30 can be moved away from the accommodating cavity 13 through the second opening, thereby achieving the effect of detaching components such as the filter assembly 20 and the water-paddling member 30. When it is necessary to empty the garbage inside the filter assembly 20, the user only needs to remove the entire apparatus from the pool water, open the top cover 11, and then detach and take out the components requiring removal, such as the filter assembly 20, through the second opening to allow operation on the filter assembly 20, thus enabling cleaning of the filter assembly 20. Apart from the filter assembly 20, electrical components of the pool cleaning apparatus, such as the drive motor, control board, and sensors, are all disposed inside the body 10, and preferably in the upper part of the body 10, to avoid issues such as water ingress into these electrical components. Certainly, the specific shape and structural configuration of the aforementioned body 10 can be adjusted as needed and are not limited to the form described in this embodiment. For example, the body 10 can be configured as a block-like component with a certain thickness, the filter assembly 20 can be directly hung on the bottom surface of the body 10, and during use, the body 10 can float on the water surface.

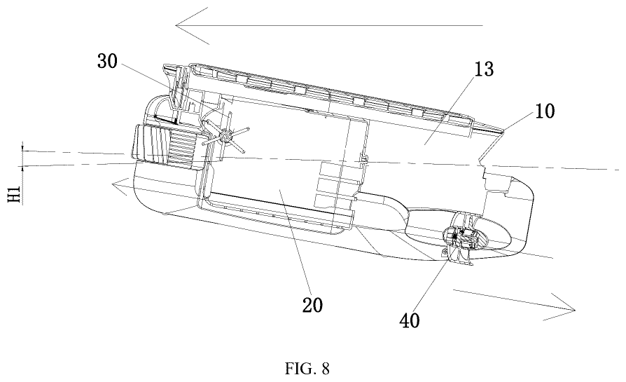

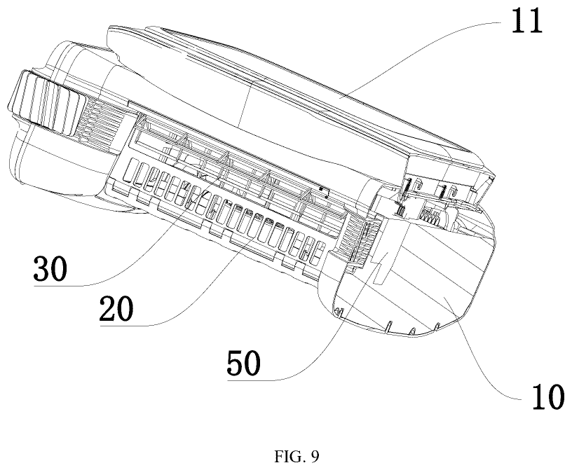

As shown in FIGS. 8 and 9, in this embodiment, the pool cleaning apparatus further includes a drive mechanism, the drive mechanism including a first drive assembly 40 and a second drive assembly 50, where the first drive assembly 40 is disposed on the body 10 and configured to generate a first driving force, the second drive assembly 50 is at least partially disposed on the body 10 and configured to generate a second driving force, the body 10 moves in water under action of the first driving force, and the second driving force is configured to drive the water-paddling member 30 to rotate relative to the body 10.

Specifically, both the first drive assembly 40 and the second drive assembly 50 include drive components. The drive components can be components such as motors, which serve to provide power. Since the first drive assembly 40 needs to achieve the forward movement of the pool cleaning apparatus on the water surface, the first drive assembly 40 in this embodiment further includes a propeller, which can be a component such as an impeller. Along the forward direction, the propeller is disposed at the rear end of the body 10. As an example, in this embodiment, propellers are arranged at both the front and rear corners of the body 10. The propellers are drivingly connected to the drive components. By rotating the propellers, water can be paddled, thereby achieving the effect of the pool cleaning apparatus moving forward on the water surface. To enable steering of the pool cleaning apparatus, the propellers in this embodiment are not all configured identically. Some propellers are arranged for longitudinal rotation, i.e., their rotation axes are transverse, while other propellers are arranged for transverse rotation, i.e., their rotation axes are longitudinal. Thus, the longitudinally rotating propellers can achieve forward movement of the pool cleaning apparatus, while the transversely rotating propellers can achieve turning of the pool cleaning apparatus, thereby allowing the pool cleaning apparatus to automatically move to various positions on the pool water surface and improving the comprehensiveness of cleaning.

As shown in FIG. 8, along the forward direction of the pool cleaning apparatus (indicated by the uppermost arrow in FIG. 8), the body 10 includes a front portion and a rear portion, the first drive assembly 40 is disposed at the rear portion of the body 10, the water-paddling member 30 is disposed at the front portion of the body 10, and the filter assembly 20 is disposed between the water-paddling member 30 and the first drive assembly 40. In the first state, the first driving force pushes the water flow to maintain the body 10 moving forward. According to action and reaction, the propeller exerts a force on the water flow (indicated by the arrow pointing downward to the right at the lower right corner of FIG. 8), while simultaneously causing the rear portion of the body 10 to experience a reaction force from the water flow (indicated by the arrow pointing upward to the left at the lower part of FIG. 8). This reaction force is substantially parallel to the axis of the propeller and is inclined upward, thereby giving the body 10 a tendency to move forward and tilt upward. Combined with the gravity of the body 10, this causes the front portion of the body 10 to tilt upward.

Since the magnitude of the first driving force generated by the propeller can vary, the specific scenarios of the first and second states will differ. For example, in a first scenario, the propeller is activated in the first state and the aforementioned reaction force exists, causing the front portion of the body 10 to tilt upward, whereas in the second state, the propeller is not activated, the aforementioned reaction force does not exist, and the body 10 lies flat on the water surface, resulting in a condition where 0<H1<H2; in a second scenario, the propeller is activated in the first state and the driving force of the propeller is relatively large, resulting in a greater reaction force and a larger upward tilt of the front portion of the body 10, whereas in the second state, the propeller is also activated, but its driving force is less than that in the first state, resulting in a relatively smaller reaction force, in which case the front portion of the body 10 still tilts upward, but the degree of tilt is less than that in the first state, also resulting in the condition where 0<H1<H2.

As the second drive assembly 50 needs to achieve the rotation of the water-paddling member 30, the second drive assembly 50 in this embodiment includes a rotational force for driving the rotation of the water-paddling member 30. The second drive assembly 50 is connected directly or via an intermediate transmission assembly to the water-paddling member 30, thereby transmitting the driving force from the drive component to the water-paddling member 30 and achieving the effect of rotating the water-paddling member 30 as a whole. Certainly, when the water-paddling member 30 moves in other modes, such as horizontal and vertical movement, the second drive assembly 50 includes a moving force for driving the water-paddling member 30 to move. The moving force includes a force parallel to the direction of the water flow entering the receiving chamber 25 and a force in the vertical direction, enabling the water-paddling member 30 to move horizontally and vertically under the driving action of the second drive assembly 50. Corresponding to the foregoing, when the water-paddling member 30 only moves horizontally without vertical movement, the second drive assembly 50 may also provide only the driving force for driving the water-paddling member 30 to move horizontally. In short, regardless of how the water-paddling member 30 moves, the second drive assembly 50 only needs to provide the corresponding driving force for driving the water-paddling member 30 to move accordingly.

In this embodiment, the pool cleaning apparatus has the maximum inclination relative to the water surface in the first state. In other operating states of the pool cleaning apparatus, such as the second state, the inclination is less than that in the first state; consequently, the distance the bottom end of the paddling portion 31 extends into the water surface is minimized. Since the bottom end of the paddling portion 31 is located below the water surface even in the first state, it remains below the water surface throughout the entire operation of the pool cleaning apparatus, thereby ensuring normal operation.

In practical design, the inclination of the pool cleaning apparatus and the positional relationship between the paddling portion 31 and the water surface depend on various factors. For example, the magnitude of the first driving force provided by the first drive assembly 40 can be adjusted. The greater the first driving force, the higher the front end of the pool cleaning apparatus tilts, making the paddling portion 31 more likely to leave the water surface. By controlling the driving parameters of the first drive assembly 40, the degree of tilt of the front end of the pool cleaning apparatus in the first state can be adjusted, ensuring the paddling portion 31 always remains below the water surface; alternatively, the overall gravity and buoyancy parameters of the pool cleaning apparatus can be adjusted to change the ease with which the apparatus tilts upward, thereby altering the relative positional relationship between the paddling portion 31 and the water surface; or, the length of the paddling portion 31 can also be adjusted so that, while maintaining the cooperative relationship with structures such as the inlet 21 as mentioned above, the paddling portion 31 can extend a sufficient length to ensure it always remains below the water surface. The specific setting parameters and other details mentioned above can be adjusted according to actual conditions and will not be elaborated in detail herein, as long as it can be ensured that the paddling portion 31 always remains below the water surface during normal operation of the pool cleaning apparatus.

It should be noted that “a plurality” in the above embodiments refers to at least two.

From the foregoing description, it can be seen that the above embodiments of this disclosure achieve the following technical effects:
1: this disclosure solves the problem that robotic pool cleaners may malfunction due to their impellers detaching from the water surface;
2: even when situations such as body tilting occur, the pool cleaning apparatus can still effectively collect and clean garbage, ensuring that the pool cleaning apparatus can always perform cleaning work stably and reliably, thereby improving operational reliability;
3: the configuration of the paddling portion can prevent garbage from being expelled out of the receiving chamber from the inlet, avoiding garbage regurgitation, improving the effect of the water-paddling member in paddling garbage into the receiving chamber, and enhancing the effectiveness of garbage collection and cleaning;
4: the design of the minimum distance L is more conducive to garbage collection, thereby improving the effectiveness of garbage collection; and
5: the overall structure is simple and easy to operate, making it highly adaptable and reliable for pool cleaning.

It should be noted that the terms used herein are only for describing the embodiments rather than for limiting the exemplary embodiments of the present application. As used herein, unless otherwise stated clearly in the context, a singular form is intended to include a plural form. In addition, it should be understood that the terms “comprise” and/or “include” as used herein indicate the presence of features, steps, operations, devices, assemblies, and/or a combination thereof.

Unless otherwise specifically stated, the relative arrangement of components and steps, numerical expressions, and numerical values set forth in these embodiments are not intended to limit the scope of this disclosure. Simultaneously, it should be understood that, for ease of description, the dimensions of the various parts shown in the accompanying drawings are not drawn to actual scale. Technologies, methods, and apparatus known to a person of ordinary skill in the art may not be discussed in detail but, where appropriate, such technologies, methods, and apparatus should be considered part of the specification. In all examples shown and discussed herein, any specific values should be construed as merely exemplary rather than limiting. Therefore, other examples of the exemplary embodiments may have different values. It should be noted that similar reference numerals and letters refer to similar items in the following accompanying drawings, and therefore, once an item is defined in one accompanying drawing, it may not require further discussion in the subsequent accompanying drawings.

In the description of this disclosure, it should be understood that the orientations or positional relationships indicated by the terms “front”, “rear”, “upper”, “lower”, “left”, “right”, “transversal”, “vertical”, “perpendicular”, “horizontal”, “top”, “bottom”, and the like are based on those shown in the accompanying drawings, and are intended only for the convenience of describing this disclosure and simplifying the description. Unless otherwise stated, these terms do not indicate or imply that the referred devices or elements must be provided with a particular orientation or constructed or operated in a particular orientation, and therefore, these terms should not be construed as limiting the scope of protection of this disclosure. The terms “inner” and “outer” refer to the inside and outside relative to the contour of a respective component.

For ease of description, spatial relative terms, such as “on”, “above”, “upper surface”, “over”, and the like, may be used herein to describe a spatial positional relationship between one device or feature and another device or feature as shown in the accompanying drawings. It should be understood that the spatial relative terms are intended to include different orientations in use or operation in addition to the orientation of the device depicted in the accompanying drawings. For example, if the device in the accompanying drawings is inverted, the device described as “above another device or construction” or “on another device or construction” will be oriented as “below another device or construction” or “under another device or construction”. Thus, the exemplary term “above” may include two orientations, namely, “above” and “below”. The device may also be oriented in other ways (rotated 90 degrees or at any other orientation), and the spatial relative descriptions used herein should be interpreted accordingly.

Furthermore, it should be noted that the use of terms such as “first” and “second” to define components is merely for the purpose of distinguishing between the corresponding components. Unless otherwise stated, these terms do not have specific meanings and therefore should not be construed as limiting the scope of protection of this disclosure.

The foregoing descriptions are merely illustrative of the exemplary embodiments of this disclosure and are not intended to limit this disclosure. Various modifications and changes may be made to this disclosure by those skilled in the art. Any modifications, equivalent replacements, and improvements made within the spirit and principle of this disclosure shall fall within the scope of protection of this disclosure.

1. A pool cleaning apparatus, comprising:
a body;
a filter assembly having a receiving chamber with an inlet for debris to enter; and
a water-paddling member movably disposed at a front portion of the body along a forward direction and adjacent to the inlet, wherein a first passage communicating with the receiving chamber is formed between the water-paddling member and the inlet, and the water-paddling member has a paddling portion;
wherein the pool cleaning apparatus comprises a first state and a second state; in the first state, the pool cleaning apparatus has the maximum inclination relative to a water surface, and the paddling portion and the inlet are at least partially located below the water surface; when the water-paddling member moves relative to the body, the paddling portion paddles water to generate a water flow toward the receiving chamber, and target debris in the water flow is paddled into the receiving chamber through the first passage; and
a draft H1 of an end portion of the paddling portion in the first state and a draft H2 of the end portion of the paddling portion in the second state satisfy 0<H1<H2, and in both the first and second states, the debris in the water flow is paddled into the receiving chamber through the first passage.

2. The pool cleaning apparatus of claim 1, wherein the pool cleaning apparatus is configured to comprise at least one of the following:
the pool cleaning apparatus has a top surface, two ends of the top surface having a first position and a second position, wherein in the first state, the top surface is at least partially exposed above the water surface, a distance H3 between the first position and a waterline is greater than a distance H4 between the second position and the waterline, and the inlet is close to the first position;
the paddling portion comprises a frame body having at least one mounting area, and at least one filter member disposed in the mounting area and connected to the frame body, wherein the filter member is provided with the filter holes, thereby filtering the water flow and reducing target debris regurgitation;
the paddling portion comprises a frame body having at least one mounting area and at least one filter member disposed in the mounting area and connected to the frame body, wherein the at least one filter member is provided with the filter holes, thereby filtering the water flow and reducing target debris regurgitation, and the frame body has a higher hardness than the at least one filter member, and in the first state, the water flow passes through the at least one filter member, and the at least one filter member has greater surface deformation than the frame body, thereby allowing the at least one filter member to undergo a deformation and form a recess for further preventing garbage regurgitation;
the water-paddling member is located downstream of the inlet and a minimum distance L along a height direction between the water-paddling member and an inner wall at a bottom of the inlet is 0-20 mm, thereby improving the effectiveness of target debris collection;
when the water-paddling member rotates, a position of an end of the water-paddling member away from a rotation axis of the water-paddling member varies between upstream and downstream of the inlet;
a periphery of the filter assembly is provided with a wall body for filtering, wherein the wall body has through holes, water inside the filter assembly flows out of the filter assembly through the through holes, and the water-paddling member is at least partially located inside the filter assembly;
the water-paddling member is disposed on or outside the filter assembly;
the paddling portion is detachably disposed on the water-paddling member;
the body comprises an accommodating cavity and a top cover, wherein the accommodating cavity has a second opening, the top cover is movably coverable over the second opening, and the filter assembly is detachably disposed within the accommodating cavity through the second opening.

3. A pool cleaning apparatus, comprising:
a body;
a filter assembly having a receiving chamber with an inlet for debris to enter; and
a water-paddling member movably disposed at a front portion of the body along a forward direction and adjacent to the inlet, wherein a first passage communicating with the receiving chamber is formed between the water-paddling member and the inlet, and the water-paddling member has a paddling portion;
wherein the pool cleaning apparatus comprises a first state in which the pool cleaning apparatus has the maximum inclination relative to a water surface, and the paddling portion and the inlet are at least partially located below the water surface; when the water-paddling member moves relative to the body, the paddling portion paddles water to generate a water flow toward the receiving chamber, and target debris in the water flow is paddled into the receiving chamber through the first passage; and the pool cleaning apparatus has a forward direction and a top surface, two ends of the top surface having a first position and a second position, wherein in the first state, the top surface is at least partially exposed above the water surface, a distance H3 between the first position and a waterline is greater than a distance H4 between the second position and the waterline, and the inlet is close to the first position.

4. A pool cleaning apparatus, comprising:
a body;
a filter assembly having a receiving chamber with an inlet for debris to enter; and
a water-paddling member movably disposed at a front portion of the body along a forward direction and adjacent to the inlet, wherein a first passage communicating with the receiving chamber is formed between the water-paddling member and the inlet, and the water-paddling member has a paddling portion provided with filter holes that allow water to pass therethrough while restricting lateral flow, thereby retaining garbage in the receiving chamber and reducing regurgitation;
wherein the pool cleaning apparatus comprises a first state in which the paddling portion and the inlet are at least partially located below a water surface, when the water-paddling member moves relative to the body, the paddling portion paddles water to generate a water flow toward the receiving chamber, the water flow containing foreign objects is partially filtered through the filter holes, and target debris in the water flow is paddled into the receiving chamber through the first passage.

5. The pool cleaning apparatus of claim 4, wherein the pool cleaning apparatus further comprises a second state, wherein the pool cleaning apparatus has the maximum inclination relative to the water surface in the first state, a draft H1 of an end portion of the paddling portion in the first state and a draft H2 of the end portion of the paddling portion in the second state satisfy 0<H1<H2, and in both the first and second states, the water flow containing foreign objects is partially filtered through the filter holes and the target debris in the water flow is paddled into the receiving chamber through the first passage.

6. The pool cleaning apparatus of claim 4, wherein the pool cleaning apparatus is configured to comprise at least one of the following:
the pool cleaning apparatus has a top surface, two ends of the top surface having a first position and a second position, wherein in the first state, the top surface is at least partially exposed above the water surface, a distance H3 between the first position and the water surface is greater than a distance H4 between the second position and the water surface, and the inlet is close to the first position;
the water-paddling member is located downstream of the inlet and a minimum distance L along a height direction between the water-paddling member and an inner wall at a bottom of the inlet is 0-20 mm, thereby improving the effectiveness of target debris collection;
when the water-paddling member rotates, a position of an end of the water-paddling member away from a rotation axis of the water-paddling member varies between upstream and downstream of the inlet;
the paddling portion comprises a frame body having at least one mounting area and at least one filter member disposed in the mounting area and connected to the frame body, wherein the at least one filter member is provided with the filter holes, thereby filtering the water flow and reducing target debris regurgitation, and the frame body has a higher hardness than the at least one filter member, and in the first state, the water flow passes through the at least one filter member, and the at least one filter member has greater surface deformation than the frame body, thereby allowing the at least one filter member to undergo a deformation and form a recess for further preventing garbage regurgitation;
a periphery of the filter assembly is provided with a wall body for filtering, wherein the wall body has through holes, water inside the filter assembly flows out of the filter assembly through the through holes, and the water-paddling member is at least partially located inside the filter assembly;
the water-paddling member is disposed on or outside the filter assembly;
the paddling portion is detachably disposed on the water-paddling member;
the filter assembly comprises a filter housing and a lifting handle connected to the filter housing, the lifting handle having a positioning portion and an operating portion, wherein the positioning portion and the operating portion are located on a side of the lifting handle away from the receiving chamber, the positioning portion is configured to cooperate with the body for positioning, the operating portion is configured to operate the filter assembly, and the filter housing has a cover that can be opened/closed; or
the body comprises an accommodating cavity and a top cover, wherein the accommodating cavity has a second opening, the top cover is movably coverable over the second opening, and the filter assembly is detachably disposed within the accommodating cavity through the second opening.

7-15. (canceled)

16. The pool cleaning apparatus of claim 2, wherein the water-paddling member is disposed on the filter assembly, the filter assembly comprises a filtering state and a detached state, wherein in the filtering state, the filter assembly is located within the accommodating cavity, and in the detached state, the filter assembly and the water-paddling member are moved away from the accommodating cavity through the second opening.

17-20. (canceled)

21. The pool cleaning apparatus of claim 1, wherein the pool cleaning apparatus further comprises:
a first drive assembly disposed at a rear portion of the body along the forward direction, wherein the first drive assembly is configured to push the body forward and tilt the body upward via a reaction force from a water flow resulting from a driving operation of the first drive assembly; or
a lifting handle disposed on a front end of the body and provided with a curved segment, wherein the curved segment employs a downwardly opening arc-shaped structure and is coveringly disposed above the water-paddling member, and a bottom end of the curved segment is located above a rotation axis of the water-padding member.

22. The pool cleaning apparatus of claim 21, wherein the pool cleaning apparatus is configured at least one of the following:
the pool cleaning apparatus further comprises a second drive assembly, wherein the second drive assembly is at least partially disposed on the body and configured to generate a second driving force, and the second driving force is configured to drive the water-paddling member to rotate relative to the body; when in the second state, the first drive assembly is not activated or a pitch angle of the body is reduced compared with that in the first state;
the water-paddling member is disposed on or outside the filter assembly;
the pool cleaning apparatus further comprises a second drive assembly connected to the water-paddling member and configured to drive the water-paddling member to rotate;
the pool cleaning apparatus further comprises a second drive assembly, wherein the second driving force comprises at least a rotational force or a moving force; wherein the rotational force is configured to drive the water-paddling member to rotate, and the moving force is configured to drive the water-paddling member to move, the moving force comprising a force parallel to a direction of the water flow entering the receiving chamber; or
wherein the filter assembly is disposed between the water-paddling member and the first drive assembly, and in the first state, the first driving force acts as a force pushing the water flow to maintain the body moving forward and inclined upward.

23. The pool cleaning apparatus of claim 3, wherein the pool cleaning apparatus further comprises
a first drive assembly disposed at a rear portion of the body along the forward direction, wherein the first drive assembly is configured to push the body forward and tilt the body upward via a reaction force from a water flow resulting from a driving operation of the first drive assembly; or
a lifting handle disposed on a front end of the body and provided with a curved segment, wherein the curved segment employs a downwardly opening arc-shaped structure and is coveringly disposed above the water-paddling member, and a bottom end of the curved segment is located above a rotation axis of the water-padding member.

24. The pool cleaning apparatus of claim 23, wherein the first drive assembly is not activated or a pitch angle of the body is reduced compared with that in the first state in the second state; or
the pool cleaning apparatus further comprises a second drive assembly connected to the water-paddling member and configured to drive the water-paddling member to rotate.

25. The pool cleaning apparatus of claim 3, wherein the pool cleaning apparatus is configured to comprise at least one of the following:
the pool cleaning apparatus has a top surface, two ends of the top surface having a first position and a second position, wherein in the first state, the top surface is at least partially exposed above the water surface, a distance H3 between the first position and a waterline is greater than a distance H4 between the second position and the waterline, and the inlet is close to the first position;
when the water-paddling member rotates, a position of an end of the water-paddling member away from a rotation axis of the water-paddling member varies between upstream and downstream of the inlet;
the paddling portion comprises a frame body having at least one mounting area; and at least one filter member disposed in the mounting area and connected to the frame body, wherein the at least one filter member is provided with the filter holes, thereby filtering the water flow and reducing target debris regurgitation;
the water-paddling member is disposed on or outside the filter assembly;
the paddling portion comprises a frame body having at least one mounting area and at least one filter member disposed in the mounting area and connected to the frame body, wherein the at least one filter member is provided with the filter holes, thereby filtering the water flow and reducing target debris regurgitation, and the frame body has a higher hardness than the at least one filter member, and in the first state, the water flow passes through the at least one filter member, and the at least one filter member has greater surface deformation than the frame body, thereby allowing the at least one filter member to undergo a deformation and form a recess for further preventing garbage regurgitation; or
the water-paddling member is located downstream of the inlet and a minimum distance L along a height direction between the water-paddling member and an inner wall at a bottom of the inlet is 0-20 mm, thereby improving the effectiveness of target debris collection.

26. The pool cleaning apparatus of claim 4, wherein the pool cleaning apparatus further comprises:
a first drive assembly disposed at a rear portion of the body along the forward direction, wherein the first drive assembly is configured to push the body forward and tilt the body upward via a reaction force from a water flow resulting from a driving operation of the first drive assembly; or
a lifting handle disposed on a front end of the body and provided with a curved segment, wherein the curved segment employs a downwardly opening arc-shaped structure and is coveringly disposed above the water-paddling member, and a bottom end of the curved segment is located above a rotation axis of the water-padding member.

27. The pool cleaning apparatus of claim 26, wherein the pool cleaning apparatus further comprises a second drive assembly, wherein the second drive assembly is at least partially disposed on the body and configured to generate a second driving force, and the second driving force is configured to drive the water-paddling member to rotate relative to the body.
